(19) United States
(12) Patent Application Publication
(10) Pub. No.: US 2010/0181821 A1
(43) Pub. Date: Jul. 22, 2010

(54) Custom Wheel with Plastic Inserts

(76) Inventor: Frank Noriega, Pico Rivera, CA (US)

Correspondence Address: Frank Noriega, 9246 Claymore st., Pico Rivera, CA, 90660, US

(21) Appl. No.: 12/567,671

(22) Filed: Sep. 25, 2009

Related U.S. Application Data
(60) Provisional application No. 61/100,647, filed on Sep. 26, 2008.

(51) Int. Cl. B60B 19/00; B60B 7/06; B60B 7/08

(52) U.S. Cl. 301/5.1; 301/37.102; 301/37.35

(57) ABSTRACT

An aftermarket custom engineered deep lip wheel cover in any design, that mates with a custom engineered aftermarket metal wheel that fits most passenger cars, light trucks, and SUV, or golf cart type vehicles. A painted metal wheel custom engineered to jointly except a custom engineered deep lip ABS plastic wheel cover. The wheel cover is designed and contoured to fit exclusively on to the custom engineered metal wheel using a plastic cap, screws, molded attachment clips, magnets, and a special bead system on the lip portion of the wheel cover.

This application emanates from a previous provisional filing: 61/100,647, filed Sep. 23, 2008

### FIELD OF THE INVENTION

This invention relates to an automotive wheel and decorative wheel cover system of universal design which will fit most automobiles and light trucks. The wheel is of steel or aluminum manufacture and the custom fit decorative wheel cover system of ABS manufacture.

### BACKGROUND OF THE INVENTION

Efforts have been made in the past to improve the appearance of original equipment automotive steel wheels. Such attempts have included colorizing or coating the wheel, physically augmenting the wheel, affixing a hub cap or wheel cover on the wheel, adding trim to the wheel, and replacing the wheel itself.

Conventional OEM steel wheels can be painted or plated to enhance their appearance. These methods require considerable effort and have a limited result in enhancing the overall appearance of such wheels.

Other efforts to improve the appearance of a conventional wheel have led to the attachment of an exterior plate or a series of plates by mounting them from the lugs. Such plates are intended to increase the width of the wheel making it appear more massive. U.S. Pat. No. 4,787,681 describes such an apparatus.

Further efforts to camouflage the appearance of a rudimentary automobile wheel have led to the incorporation of a cap or cover. Such caps can be plastic, metal, or wire spoked. The plastic caps are typically formed by injection molding. The metal caps are formed by casting or a blanking and drawing operation. U.S. Pat. Nos. 1,976,542, 3,095,241, and 3,496,753 show examples of wheel caps and covers and the method of making them. Such caps or covers often suffer the shortcoming that they present little more than surface decoration providing little in the way of optical illusion persuasive of a faithful reproduction of a cast wheel.

It has also been proposed to add wheel trim to a rudimentary wheel or to a hub cap mounted on a wheel. The wheel trim is often employed in an effort to make the hub cap or wheel appear wider and can be configured to obscure from view the junction between the tire and the wheel. U.S. Pat. No. 3,798,728 suggests such an approach.

Often consumers are driven to replace the entire wheel in a quest for stylish transport. Previous solutions in the nature of augmenting the wheel sometimes presented a flimsy and visually unappealing wheel design. Thus, various forms of decorative automobile wheels themselves have been proposed. Aftermarket automobile wheels are typically cast aluminum or stamped and rolled steel wheels. For the cast aluminum wheel, the surface to be exposed to view is machined with a lathe cutting tool to remove rough edges and provide a smooth texture and luster. The lathing process leaves spiral markings indicative of the process. A machined cast wheel has a unique appearance that is valued by consumers.

Decorative machined wheels, however, are expensive to manufacture and finish. The cost of making even the least expensive decorative machined cast wheel can be four times that for steel wheels augmented by other methods of appearance augmentation, such as wheel covers. Decorative automobile wheels are also bulky, heavy, and cumbersome to package and transport to retail outlets.

Thus, consumers are faced with the choice of an expensive machined cast wheel or less expensive, though less attractive, devices. These less expensive devices do not have the improved appearance resulting from the machining process. They lack the high quality appearance that consumers normally associate with a high-end machined cast aluminum wheel.

Ordinary wheel covers have not achieved a resemblance to quality machined wheels that would give a consumer an inexpensive alternative to expensive cast machined wheels. Such wheels lack the depth and features required to satisfactorily replicate the visual, dimensional appeal of an expensive alloy wheel.

### SUMMARY OF THE INVENTION

The Custom Wheel invention improves and replaces traditional customer aftermarket ABS wheel covers to simulate and offer a more authentic appearance of an aftermarket chrome or painted alloy wheel by offering the detailed characteristics of a chrome or painted aftermarket alloy wheel such as a deep lip and interchangeable plastic inserts. The wheel cover is joined together with a specially designed and engineered universal fit steel or aluminum wheel to achieve the details of a deep on the wheel cover. This invention is designed to compete with an aftermarket alloy wheel by offering a dramatically reduced manufacturing cost and a subsequently affordable product for the consumer. This wheel system is superior to other decorative wheel covers because the decorative ABS wheel covers are engineered to be bolted onto a proprietary universal steel or aluminum wheel specifically designed and manufactured for the customer wheel covers enabling the use of reliable and concealable bolt fasteners as opposed to unreliable and unsecure snap-on fastening designs.

### BRIEF DESCRIPTION OF THE DRAWINGS

FIG. 1 is the front/right side perspective of the device.

FIG. 2 is the front of the device

FIG. 3 is the inside view of the ring device

FIG. 4 is the front view of the ring

FIG. 5 is the cross section views.

FIG. 6 is the top detail view of the lip ring

### DESCRIPTION OF THE PREFERRED EMBODIMENT

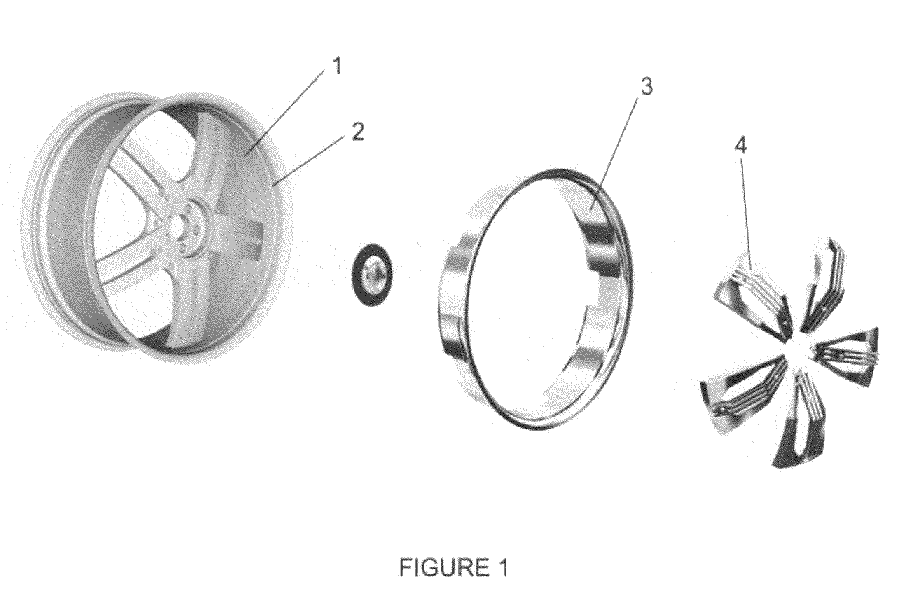

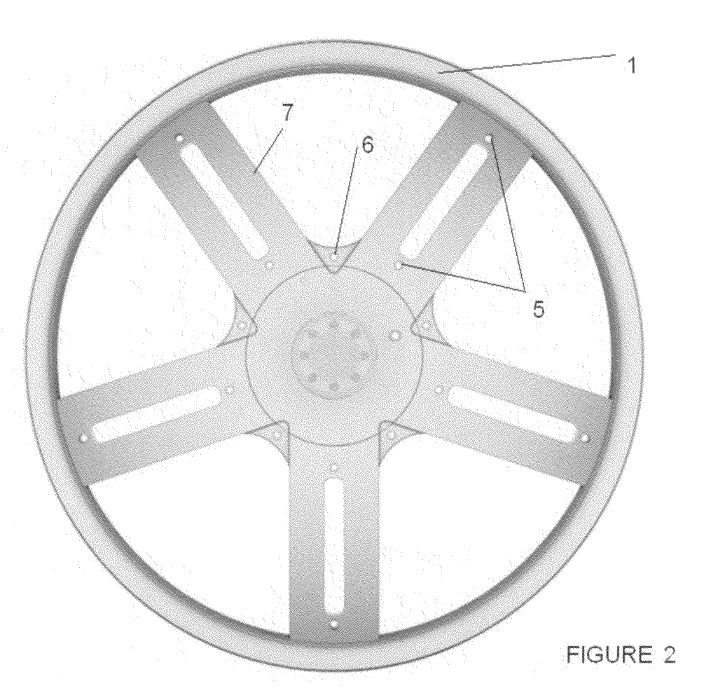

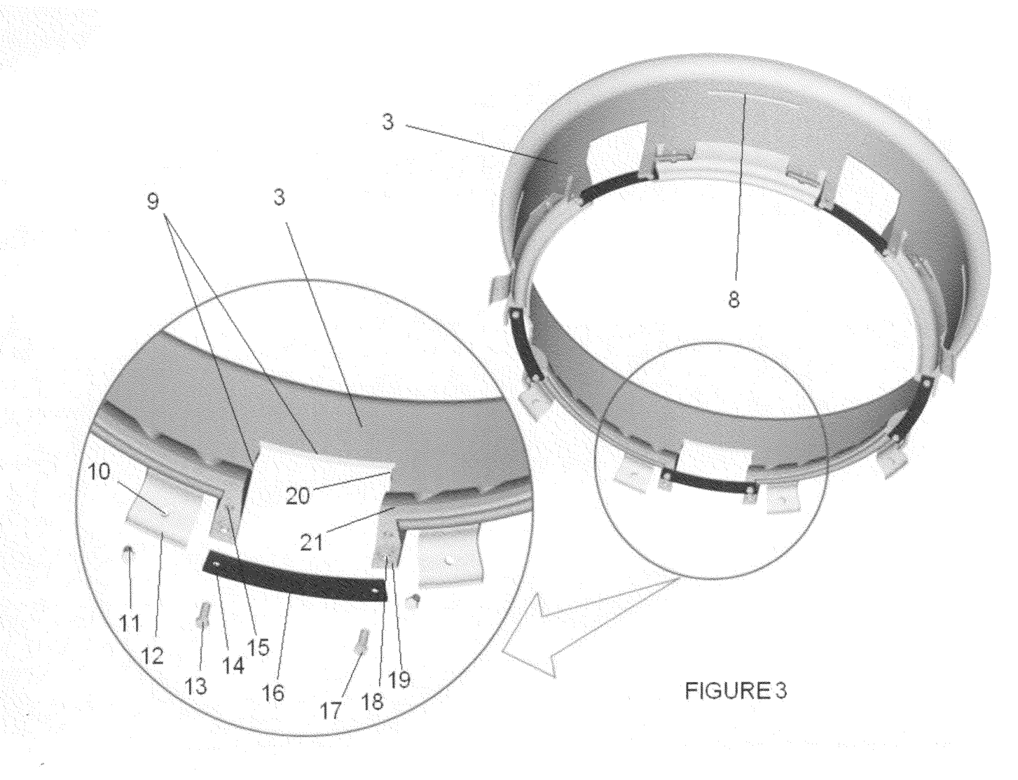

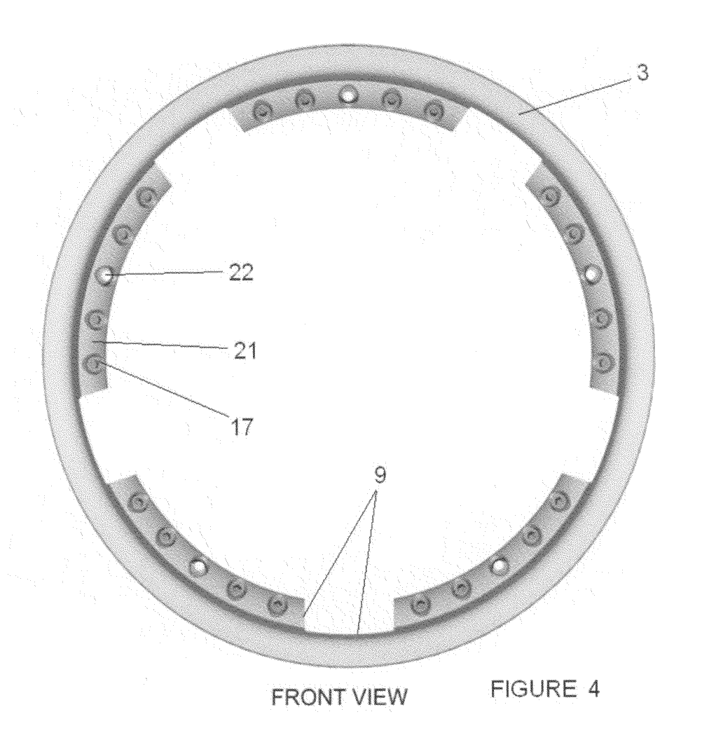

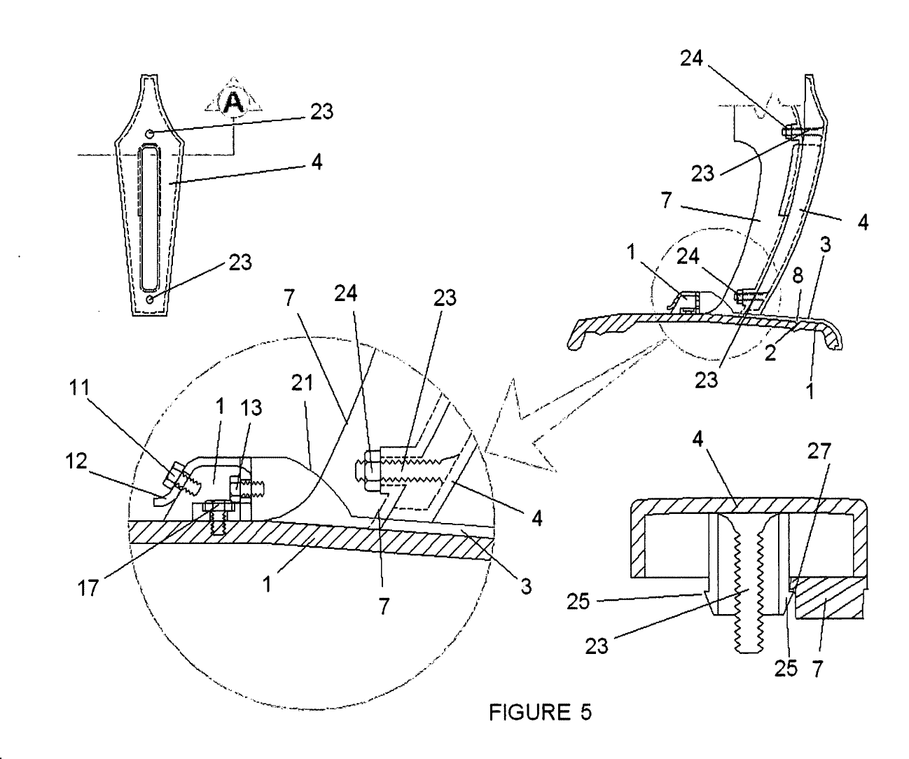

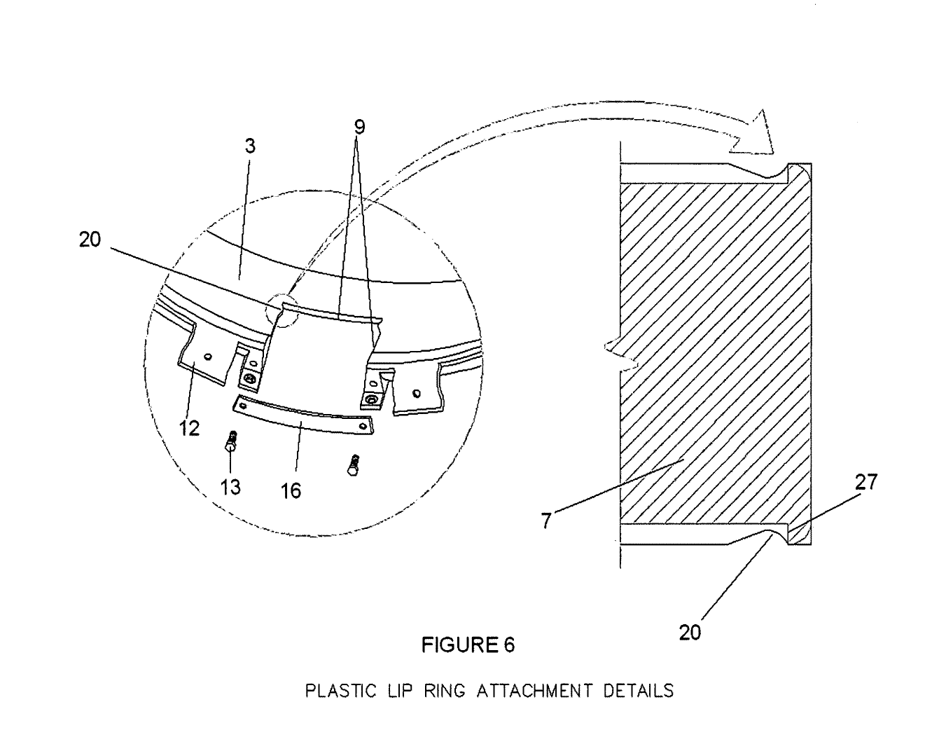

FIG. 1 is a wheel (1) that is engineered to accept an ABS plastic lip ring using screws and molded clips on the lip ring (3). The inserts (4) are attached to the fact of the spokes of the wheel (1) using threaded nuts on the backside of the spokes which screw onto threaded posts molded on the backside of the insert (4) FIG. 2 shows the wheel (1) with the spokes (7) and the holes 5, and 6 which are the attachment holes used to secure the plastic inserts (4) FIG. 3 shows the plastic lip ring (3) with cut out recess features (9) which enables the lip ring (3) to wrap around the sides of the spoke (7) of a wheel (1). The lip ring (3) is also secured to the spoke (7) of the wheel using a bar (16) with two holes (14) on it. The holes (14) on the bar are lined up with the holes (15) on the back side of the lip ring (3), the bar (16) is secured to the lip ring (3) and the back side of the spoke (7) using screws (17) The lip ring (3) is also secured to the wheel with molded clips (12) that snap onto the wheel to secure the lip ring (3) to the wheel (1). The clips then are secured with screws (11) through the holes (10) on the clips, and are screwed to the wheel (1) The lip ring (3) is also secured to the wheel (1) using molded recess tabs (19) on the back side of the lip ring (3) with holes (18) on the molded recess tabs. Screws (17) are used to secure the lip ring (3) to the wheel (1) The lip ring (3) is also secured to the spoke (7) of the wheel (1) using molded humps (20) along the inside edge of the recess cut out (9). The lip ring (3) is also secured to the wheel (1) using molded protuberances on the outer side of the lip ring (3) The molded protuberances are mated and snap together with a groove (2) on the wheel (1) FIG. 4 shows the front view of the lip ring (3) along with recessed cut out attachment (9) It also shows an optional attachment area for the insert (4) or decorative screws (17) to the plurality of holes on the walls (21) of the lip ring (3) The opposite end of the insert (4) is attached to the hole (6) using a nut (24) which is screwed onto the threaded molded post (23) of the insert (4) FIG. 5 shows the molded post (23) on the back side of the insert (4) which attaches the insert (4) through the hole (5) on the face of the spoke (7) which is then secured to the spoke (7) using a nut (24) It also illustrates the molded clip (12) which snaps to the wheel (1) then secured by a screw (11) Also shown is the recess tab (19) secured to the wheel (1) using screw (17) also shown are molded clips (25) on the back side of the insert (4) which snaps behind the back side ledge (27) of the spoke (7) FIG. 6 shows the humps (20) molded to the edge of the recess cut out (9) which is used to snap and secure the lip ring (3) behind the ledge (27) which is molded on the back side edge of the spoke (7) of the wheel (1)

What is claimed is:

1. A universal fit metal wheel (1) of any design, size, or plurality of spokes, used with a wide lip (9) engineered to accept a wheel cover (20) with a wide lip (26).

2. A universal fit metal wheel wherein; the spoke (3) of the metal wheel (1) has one or more threaded holes (7) positioned anywhere on the face of the spoke (3) or on the flange (2) which is used for attachment of the ABS wheel cover (20) using screws (25) or nuts (32).

3. A universal fit metal wheel wherein; the metal center portion (8) of the metal wheel (1) has a flange (2) which connects to the spoke (3) which is used to attach the ABS wheel cover (20) to the wheel (1).

4. A universal fit metal wheel of claim 1 wherein; the wheel (1) has a plurality of special engineered holes of any shape (6) with steps (13) to accept a special engineered universal fit metal washer system (15).

5. A universal fit metal wheel of claim 1 wherein; the metal washer (15) is designed with a step (19) to fit and join on the step (13) of the lug hole of the wheel (6). The lug nut hole (5) is positioned on the washer (15) accordingly to fit bolt circle patterns of any vehicle. The washer has a molded mound of extra material (18) to strengthen the washer around the hole (5) perimeter.

6. A universal fit metal wheel of claim 1 wherein; a metal ring (10) is attached to the hub diameter (4) of the wheel (1) by welding it (11) to one or more weld surfaces (20).

7. A universal fit metal wheel of claim 1 wherein; the ring (10) is then utilized to attach the ABS wheel cover (20) to the ring (10) by the use of screws (25) which secure the wheel cover to the threaded holes (14) on the ring (10).

8. A universal fit metal wheel of claim 1 wherein; the cap screw tab (12) is used to attach and secure both the ABS wheel cover (20) and the ABS center cap (21) using a screw (25).

9. A universal fit metal wheel of claim 1 wherein; the cap screw (25) is used to attach through the hole (24) of the center cap (21) which then is attached to the cap screw tab (12) located on the ring (10).

10. A universal fit metal wheel of claim 1 wherein; the outer diameter back side edge of the center cap (21) seats on the cap seat area (29) of the ABS wheel cover (20) to secure the wheel cover to the ring (10) using the pressure of the screw (25) which applies pressure to the center cap (21) when attached and tightened through the hole (24) of the center cap (21) when tightened to the cap screw tab (12).

11. A universal fit metal wheel of claim 1 wherein; the wheel cover (20) is secured and makes contact to the lip of the wheel (9) by a press fit of the molded ribs (9) located on the back side of the wheel cover lip (26) when joined together.

12. A universal fit metal wheel of claim 1 wherein; the wheel cover (20) is secured to the wheel (1) by molded clips (27) located on the upper back side of the rivet wall (22) of the wheel cover (20). The clips (27) snap on behind the back edge of the flange (2) of the wheel (1).

13. A universal fit metal wheel of claim 1 wherein; the rivet wall (22) located on the wheel cover (20) is used to cover the flange (2) and to accommodate the molded clips (27) and to receive detachable decorative screws (25) located and attached along the face of the rivet wall (23).

14. A universal fit metal wheel of claim 1 wherein; the wheel cover is attached by molded clips (37) located on the back side edge of the center cap seating area (29) then snapped on to the inter edge of the ring (10) located on the wheel hub area (4).

15. A universal fit metal wheel of claim 1 wherein; the wheel cover (20) has a molded and threaded post (31) located on the backside of the wheel cover spoke (30) which slips through the threaded hole (7) located on the spoke (3) of the wheel (1) and then secured in place by nut (32) which attaches to the post (31).

16. A universal fit metal wheel of claim 1 wherein; the back side top of the clip (27) has one or more threaded holes (35) which one or more holes (34) located on the bracket (33) is lined up together, to accept one or more screws (36) to secure the bracket to the wheel cover (20), which secures the wheel cover (20) to the wheel (1).

17. A universal fit metal wheel of claim 1 wherein; the back side of the seating area (29) has one or more thick platforms with holes (38) to accommodate the attachment screws (25) to secure the wheel cover (20) to the wheel (1).
